(19) United States
(12) Patent Application Publication
(10) Pub. No.: US 2023/0236398 A1
(43) Pub. Date: Jul. 27, 2023

(54) HELIOSTAT FIELD LAYOUT SYSTEM AND METHOD

(71) Applicant: Heliogen Holdings, Inc., Pasadena, CA (US)

(72) Inventor: Steven Edward Schell, Arcadia, CA (US)

(21) Appl. No.: 18/157,386

(22) Filed: Jan. 20, 2023

Related U.S. Application Data
(60) Provisional application No. 63/303,788, filed on Jan. 27, 2022.

(51) Int. Cl. G02B 19/00; G02B 26/08; G02B 7/183

(52) U.S. Cl. CPC G02B 19/0019; G02B 7/183; G02B 19/0042; G02B 26/0816

(57) ABSTRACT

A heliostat field layout for a concentrated solar power (CSP) plant includes a plurality of heliostats arranged adjacent each other (e.g., side-by-side) in a first arc spaced from a tower comprising a solar receiver. A second plurality of heliostats are arranged adjacent each other (e.g., side-by-side) in one or more additional arcs spaced from each other and spaced from the first arc, each additional arc spaced from a previous of the additional arcs by a radial distance that defines an aisle, the radial distance between a pair of adj acent arcs being equal to or greater than the radial distance between a previous pair of adjacent arcs in a direction away from the tower. The heliostats are arranged in the arcs in a non-staggered manner.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

### Field

The present disclosure is directed to heliostats, and more particularly to a system and method for a heliostat field layout.

### Description of the Related Art

Traditionally, most heliostat fields use a “radial stagger” layout pattern (e.g., partially shown in FIG. 1). In these arrangements, heliostats are spaced in circular arcs and are spaced relatively far apart within those arcs. Heliostats in successive arcs are located angularly between those in the arcs before and after them, which limits blocking (e.g., light from one heliostat being blocked by a heliostat closer to the tower). In addition to limiting blocking, this pattern spaces heliostats far enough to prevent them from colliding with one another when they move with an “azimuth-elevation” kinematic.

However, the “radial stagger” layout has deficiencies when used with small heliostats. For example, as the heliostats become smaller, the spacing between also shrinks, reducing access to the field of heliostats (e.g., between heliostats, for example, for maintenance and cleaning). For very small heliostats, a radial stagger pattern results in the complete absence of clear aisles accessible for installation, cleaning and maintenance of the heliostats. Other deficiencies of such “radial stagger” layout include the relatively long distances between adjacent heliostats, which increases the length of electrical cabling between them, and longer travel distances required for cleaning and maintenance of the heliostats.

### SUMMARY

In accordance with one aspect of the invention, an improved heliostat field layout is needed that provides for adequate access to the field of heliostats for installation, maintenance and/or cleaning, especially when small heliostats are used (e.g., heliostats having a dimension of 1.6 m x 1.2 m, or twice or three times as large).

In accordance with one aspect of the disclosure, a heliostat field layout system for a concentrated solar power (CSP) plant is provided. The heliostat field layout system includes a plurality of heliostats arranged adjacent each other in a first arc spaced from a tower comprising a solar receiver. The heliostat field layout system also includes a second plurality of heliostats arranged adjacent each other in one or more additional arcs spaced from each other and spaced from the first arc. Each of the one of more additional arcs are spaced from a previous of the one or more additional arcs by a radial distance that defines an aisle. The radial distance between a pair of adjacent arcs is equal to or greater than the radial distance between a previous pair of adjacent arcs in a direction away from the tower. Each heliostat in the plurality of heliostats and in the second plurality of heliostats is configured to pivot about a pitch axis and about a roll axis.

In accordance with another aspect of the disclosure, a method for implementing a layout of heliostats in a heliostat field of a concentrated solar power (CSP) plant is provided. The method comprises arranging a plurality of heliostats adjacent each other in a first arc spaced from a tower comprising a solar receiver. The method also comprises arranging a second plurality of heliostats adjacent each other in one or more additional arcs spaced from each other and spaced from the first arc. Each of the one of more additional arcs is spaced from a previous of the one or more additional arcs by a radial distance that defines an aisle. The radial distance between a pair of adjacent arcs is equal to or greater than the radial distance between a previous pair of adjacent arcs in a direction away from the tower. Each heliostat in the plurality of heliostats and in the second plurality of heliostats is configured to pivot about a pitch axis and about a roll axis.

### BRIEF DESCRIPTION OF THE DRAWINGS

FIG. 1 is a partial view of a conventional radial stagger layout of heliostats in a heliostat field.

FIG. 2 is a schematic elevation view of a concentrated solar power (CSP) system with an array of heliostats and a receiver.

FIG. 3 is a schematic layout of heliostats in a heliostat field.

FIG. 4 is a partial view of the layout of heliostats in FIG. 3 as viewed from a receiver of a CSP system.

FIG. 5 is a schematic block diagram illustrating a processing system for determining a layout of heliostats in a heliostat field.

FIG. 6 is a flow chart of a process or method for determining a layout of heliostats in a heliostat field.

FIG. 7 is a flow chart of a process for implementing a layout of heliostats in a heliostat field.

### DETAILED DESCRIPTION

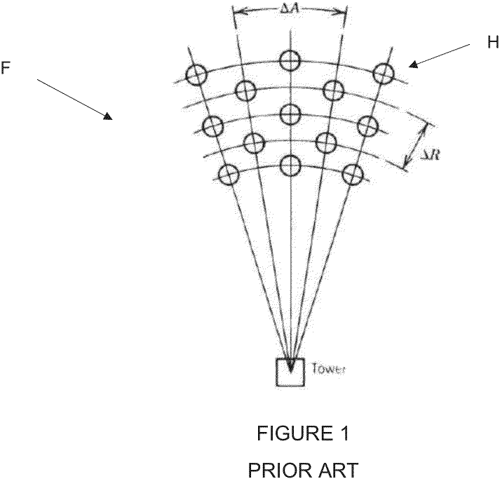

FIG. 1 shows a partial view of a conventional layout of heliostats H relative to a tower T in a heliostat field F. Rows of heliostats H are spaced by a distance ΔR and heliostats H in a row are angularly spaced from each other by an angle ΔA. The heliostats H are radially staggered so that the heliostats H are spaced relatively far apart within each row (e.g., spaced greater than twice the lateral dimension of a heliostat H). The heliostats H in successive rows are located angularly between those in the rows before and after them.

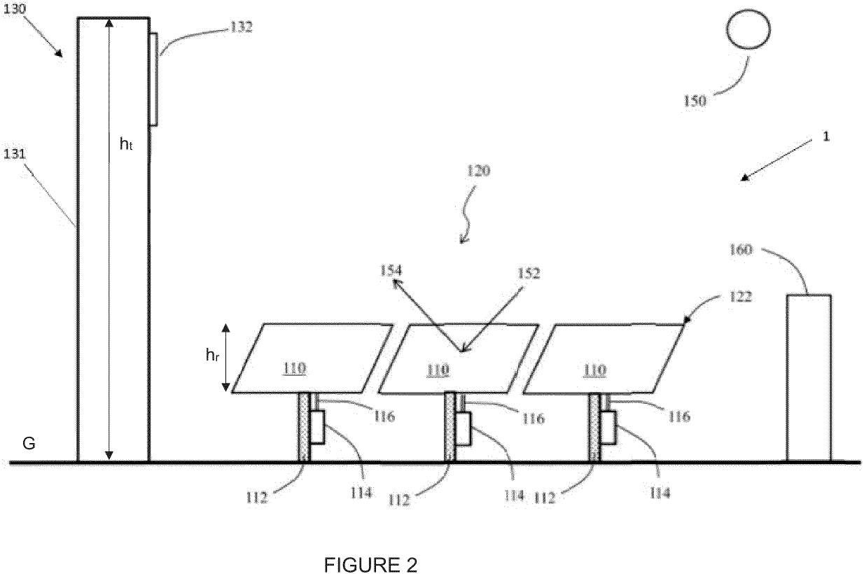

FIG. 2 shows an elevation view of a heliostat array or field 120 and a receiver assembly 130 of a concentrated solar power (CSP) system or plant 1. The receiver assembly 130 can have a solar flux receiver 132 (e.g., a receiver, which can receive solar flux via an aperture) disposed on top of a tower 131. The heliostat array or field 120 includes one or more (e.g., multiple) heliostats 122 that are distributed in two dimensions in proximity to the receiver assembly 130. Each heliostat 122 includes a mirror 110 pivotably coupled (e.g., about a pitch axis and/or about a roll axis) to a frame or stanchion 112 affixed to (e.g., disposed on, embedded in) the ground and/or to other heliostats. Each heliostat 122 further includes a tracking controller 114 operable to determine the proper orientation of its associated mirror 110 throughout the day. A mirror 110 is properly oriented when the incoming light 152 from the sun 150 is reflected 154 to (e.g., concentrated on) the receiver assembly 130, specifically the solar flux receiver 132 (e.g., the aperture of the solar flux receiver 132). In another implementation, all of the heliostats 122 in the heliostat array or field 120 share the same tracking controller that determines the proper orientation of the mirrors 110 of the heliostats 122 throughout the day. If the actual orientation of the mirror 110 differs from the proper orientation at that instant, the tracking controller 114 energizes actuator(s) 116 that drive the mirror 110 to the proper orientation (e.g., pitch angle and/or roll angle of the mirror 110). Advantageously, movement of the heliostats 122 (e.g., movement of the mirrors 110) about a pitch axis and a roll axis inhibits (e.g., prevents) collisions between adjacent heliostats 122 (e.g., in a row of adjacent or side-by-side arrangement of heliostats, as described below). The tower 131 has a height hₜ and the heliostat 122 (e.g., the mirror 110) has a height hᵣ above the ground G.

In one implementation, the heliostat 122 (e.g., the mirror 110 of the heliostat 122) can have a size of between about 1.6 m x 1.2 m and about 4.8 m x 3.6 m (e.g., a size of 1.6 m x 1.2 m, a size of 3.2 m x 2.4 m, a size of 4.8 m x 3.6 m). In another implementation, the heliostat 122 (e.g., the mirror 110 of the heliostat 122) can have a size of between about 2 m² and about 6 m² (e.g., a size of about 2 m², 3 m², 4 m², 5 m² or 6 m²). The heliostat 122 (e.g., the mirror 110 of the heliostat 122) can have a rectangular outer shape (e.g., perimeter shape). In other implementations, the heliostat 122 (e.g., the mirror 110 of the heliostat 122) can have other suitable shapes (e.g., square, hexagonal, octagonal).

The solar tracking system further includes a controller 160 in communication with the tracking controller 114 and actuators 116 for each of the heliostats 122. In particular, the controller 160 provides power to each of the tracking controller 114 as well as the power to energize the associated actuators 116 that aim the associated mirror 110 (e.g., toward the solar flux receiver 132).

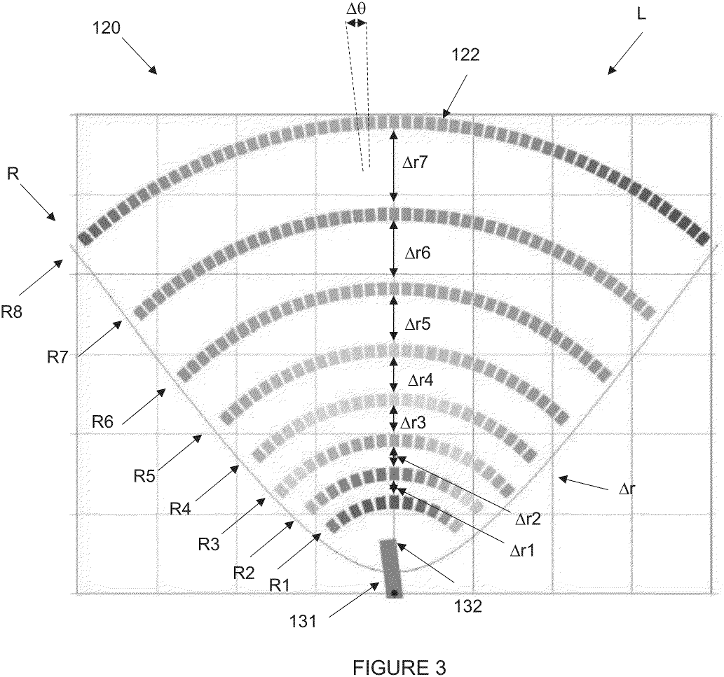

FIG. 3 shows a layout L of the heliostat field 120 of heliostats 122 relative to the tower 131 with the solar flux receiver 132. The layout L includes one or more rows R spaced from each other and from the tower 131. In the illustrated example, the layout L has eight rows R1 to R8 of heliostats 122. However, the layout L can have fewer or more rows. Each of the rows (e.g., R1 to R8) of heliostats 122 can have an arc shape (e.g., the heliostats 122 are arranged in an arc). In one example, the arc is a circular arc defined by a radius (of curvature), for example extending from the tower 131. In one example, the arc does not completely encircle the tower 131 (e.g., extend less than 360 degrees, such as 270 degrees, 210 degrees, 180 degrees around the tower 131). In another example, the arc completely encircles the tower 131.

Each row R can be spaced from another row R by a distance Δr (e.g., a radial distance, as measured from the tower 131). With reference to FIG. 3, the second row R2 can be spaced from the first row R1 by a first distance Δr1 (e.g., first radial distance) along the length of the first and second rows R1, R2, the third row R3 can be spaced from the second row R2 by a second distance Δr2 (e.g., second radial distance) along the length of the second and third rows R2, R3, the fourth row R4 can be spaced from the third row R3 by a third distance Δr3 (e.g., third radial distance) along the length of the third and fourth rows R3, R4, the fifth row R5 can be spaced from the fourth row R4 by a fourth distance Δr4 (e.g., fourth radial distance) along the length of the fourth and fifth rows R4, R5, the sixth row R6 can be spaced from the fifth row R5 by a fifth distance Δr5 (e.g., fifth radial distance) along the length of the fifth and sixth rows R5, R6, the seventh row R7 can be spaced from the sixth row R6 by a sixth distance Δr6 (e.g., sixth radial distance) along the length of the sixth and seventh rows R6, R7, and the eighth row R8 can be spaced from the seventh row R7 by a seventh distance Δr7 (e.g., seventh radial distance) along the length of the seventh and eighth rows R7, R8.

In one implementation, the radial distance Δr between each row R and a previous row R (e.g., immediately previous row R) increases in a direction away from the tower 131, which advantageously inhibits (e.g., reduces, prevents) blocking of a heliostat in a row R by a heliostat in a previous row R (e.g., reduces, inhibits or prevents reflected by a heliostat in a row from being blocked by a heliostat in a previous row). In another implementation, the radial distance Δr between some of the rows R can be the same. For example, in a region closest to the tower 131, the minimum spacing between adjacent rows R that is needed to access the heliostats 122 in the row R can be greater than the minimum spacing needed to avoid blocking of sunlight by a previous row R, in which case the radial distance Δr can be the same between several of the rows R because the minimum distance for access dictates the spacing between rows R. After a few rows R having said equal spacing (e.g., the farther the rows are located from the tower 131), the minimum spacing needed to avoid blocking becomes greater than the minimum distance needed to access the heliostats 122 in a row R, so that the radial distance Δr between adjacent rows beings to increase since it is dictated by the minimum spacing needed to avoid blocking by a previous row R. With reference to FIG. 3, the second distance Δr2 is greater than the first distance Δr1, the third distance Δr3 is greater than the second distance Δr2, the fourth distance Δr4 is greater than the third distance Δr3, the fifth distance Δr5 is greater than the fourth distance Δr4, the sixth distance Δr6 is greater than the fifth distance Δr5, and the seventh distance Δr7 is greater than the sixth distance Δr6. In another example, the second distance Δr2 is equal to the first distance Δr1, the third distance Δr3 is greater than the second distance Δr2, the fourth distance Δr4 is greater than the third distance Δr3, the fifth distance Δr5 is greater than the fourth distance Δr4, the sixth distance Δr6 is greater than the fifth distance Δr5, and the seventh distance Δr7 is greater than the sixth distance Δr6. Advantageously, the radial distance Δr between adjacent rows defines an aisle that facilitates (e.g., makes easier) the cleaning and/or maintenance of the heliostats 122 (e.g., by providing aisles of sufficient size to allow personnel to access the heliostats 122 in a row). Another advantage of the layout L is that the radial distance Δr between adjacent rows is greater than a minimum radial distance rₘᵢₙ that inhibits (e.g., reduces, prevents) blocking of a heliostat in a row R by a heliostat in a previous row R, thereby providing the heliostat field 120 with high optical efficiency (e.g., due to little or no overlap between heliostats 122 and therefore little or no blocking of sunlight of one heliostat by another).

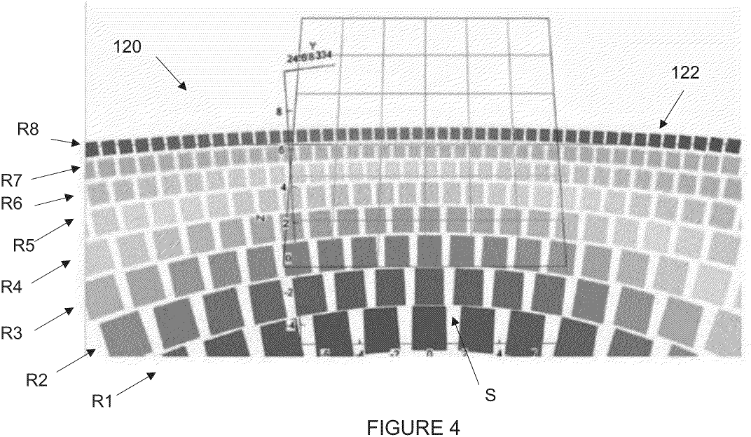

With continued reference to FIG. 3, the heliostats 122 in each row R (e.g., in each of the rows R1 to R8) are arranged adjacent each other so that they are spaced by an angular spacing Δθ (e.g., an angle in degrees, in radians). In one example, the angular spacing Δθ of heliostats 122 in a row R varies along the length of the row R. In another example, the angular spacing Δθ of heliostats 122 in a row R is constant or substantially constant along the length of the row R. The angular spacing Δθ of heliostats 122 in different rows R (e.g., in different rows of the rows R1 to R8 in FIG. 3) can vary (e.g., the angular spacing Δθ of heliostats 122 in one row can vary from the angular spacing Δθ of heliostats 122 in another row). The heliostats 122 in each row R are arranged adjacent each other (e.g., side-by-side, tangentially) so that a space S (see FIG. 4) between adjacent heliostats 122 is smaller than a lateral dimension (e.g., width) of a heliostat 122. That is, adjacent heliostats 122 in a row R are spaced from each other so that the space S in between the adjacent heliostats 122 is not large enough to accommodate another heliostat 122 in between them. As shown in FIG. 3, the heliostats 122 in the rows R of the heliostat field 120 are not staggered from row to row, but instead the heliostats 122 in each row R of the heliostat field 120 are adjacent each other (e.g., side-by-side, tangentially), in the manner described above. This non-staggered (e.g., side-by-side, tangential) arrangement of the heliostats 122 advantageously provides the heliostat field 120 with high density (e.g., area of mirrors 110 of heliostats 122 per land area), and a reduction in electrical cabling, travel distance for cleaning and travel distance for maintenance between heliostats 122 in each row R. As shown in FIG. 4, when viewed from the tower 131 (e.g., from the receiver 132), the field of view (from the receiver 132) is almost entirely filled with mirrors 110 of the heliostats 122, resulting in a higher field density per unit of land area than if the heliostats were staggered. In another implementation, an advantage of the layout L is that the angular spacing Δθ between adjacent heliostats 122 in a row inhibits (e.g., reduces, prevents) a heliostat 122 in the row R from casting a shadow on another heliostat 122 in the same row R.

The layout L of heliostats 122 in the heliostat field 120 can be optimized based on multiple parameters, for example the land area available (I1), the amount of power desired out of the heliostat field (I2), and the cost per heliostat (I3). Additional parameters (e.g., size or dimensions of the heliostat 122, for example, of the mirror 110 of the heliostat 122, height of the heliostat 122 or mirror 110 from the ground G, height of the tower 131 from the ground G) can be considered. The input parameters can be processed by an optimizer (using a heliostat layout algorithm) that weights the different parameters to provide the most cost effective layout L of heliostats 122 for the heliostat field 120 for the set of input parameters (I1, I2, I3, etc.).

As part of the optimization of the layout L, the minimum radial distance rₘᵢₙ for each row R of heliostats 122 to inhibit (e.g., prevent) blocking losses can be calculated using the formula below:

$${r}_{min} \left(r\right) = \frac{{h}_{r}}{{h}_{t}} {\left({r}^{2} + {h}_{t} {}^{2}\right)}^{1 / 2}$$

where r is the radius (measured from the tower 131), hᵣ is the height of the mirror 110 of the heliostat 122 (e.g., a height of 1.6 m in a mirror 110 sized 1.2 m x 1.6 m), and hₜ is the height of the tower 131 above the ground. Similarly a minimum angular position or distance θₘᵢₙ can be calculated for each heliostat 122 to inhibit (e.g., prevent) collisions between adjacent heliostats 122. This equation(s) can be evaluated at or beyond the midpoint between a current row and the next row (e.g., to reduce or combat a truncation error in an explicit forward difference calculation scheme).

The radial distance Δr between rows R of heliostats 122 and the angular spacing Δθ between heliostats 122 in a row R can be given by the following relationships:

$$\text{Δ} r = {r}_{min} \left(r\right) ⋅ S R \left(r , θ\right) ,$$

$$\text{and} \text{Δ} θ \text{=} {θ}_{min} \left(r\right) ⋅ S T \left(r , θ\right) .$$

where SR is a scaling factor that allows the rows R to be spaced closer together than the minimum radial distance rₘᵢₙ or father apart than the minimum radial distance rₘᵢₙ. For example, the scale factor SR can allow the rows R of heliostats 122 to be placed closer together than the minimum radial distance rₘᵢₙ to accept an increase in blocking loss in exchange for higher field density and more power (per unit of land area) and smaller land area used, or allow the rows R of heliostats 122 to be placed farther apart than the minimum radial distance rₘᵢₙ to prevent blocking (e.g., zero out blocking loss) but increase the land area used. Similarly, ST is a scaling factor that allows the heliostats 122 in a row R to be spaced (tangentially, side-by-side) closer together than the minimum angular position or distance θₘᵢₙ or father apart than the minimum angular position or distance θₘᵢₙ. For example, the scale factor ST can allow the heliostats 122 in a row R to be placed closer together (e.g., tangentially, side-by-side) than the minimum angular position or distance θₘᵢₙ to accept an increase in potential collision between heliostats 122 and losses due to shadows cast on heliostats 122 in the row R by other heliostats 122 in the same row R in exchange for higher field density and more power (per unit of land area) and smaller land area used for the heliostat field 120, or allow the heliostats 122 in a row R to be placed farther apart than the minimum angular position or distance θₘᵢₙ to prevent collisions (e.g., zero out collision risk or loss) and reduce or zero out (e.g., eliminate) losses from shadows cast by heliostats 122, but decrease field density (e.g., density of heliostats 122 in the heliostat field 120) and increase the land area used for the heliostat field 120.

The equations above can in one example be further expanded a linear equations, as shown below:

$$F \left(r , θ\right) = {F}_{r} \left(r\right) + {F}_{θ} \left(r\right) ⋅ θ .$$

$$\text{and} {F}_{i} \left(r\right) = {m}_{{F}_{t}} ⋅ r + {h}_{{F}_{r}}$$

Where the equations vary linearly with radius r and angle θ, and m_{Fi} and b_{Fi} are variables. The equations above can be processed by the optimizer (using a heliostat layout algorithm).

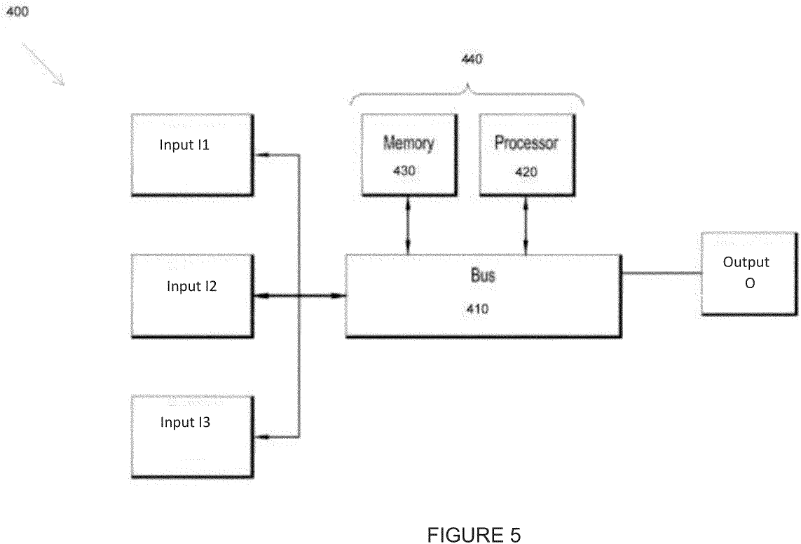

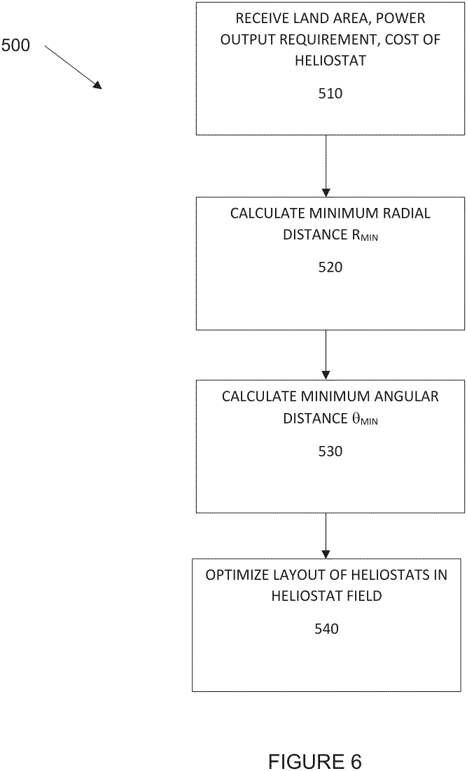

FIG. 5 is a block diagram illustrating a processing system 400 for performing the algorithm. The processing system 400 includes a bus 410 or other communication mechanism for communicating information. The system 400 also includes a processor 420 and memory 430 in communication with the bus 410 and providing a computing unit 440. The processor 420 processes information and executes instructions, such as the heliostat layout algorithm described herein (e.g., method 500 in FIG. 6). The memory 430 stores information and instructions to be executed by the processor 420, such as the heliostat layout algorithm discussed herein (e.g., method 500 in FIG. 6). The bus 410 receives the inputs I1, I2, I3,etc. for use by the processor 420 in processing information and executing instructions, such as the heliostat layout algorithm in the manner described herein (e.g., method 500 in FIG. 6). Additionally, once the algorithm has optimized the heliostat layout, the processing system 400 can provide an output O with, for example, instructions on radial spacing between rows or arcs of the heliostat field 120 and instructions on angular spacing between heliostats in the same row or arc, which can be carried out during installation of the heliostats 122 of the heliostat field 120.

FIG. 6 shows a process or method 500 for determining a layout of heliostats in a heliostat field (e.g., the layout L of heliostats 122 in the heliostat field 120). The method 500 includes the step 510 of receiving a number of inputs, such as available land area for the heliostat field, power output requirement from the heliostat field, and unit cost of a heliostat. Additional inputs, such as size or dimensions of a heliostat (or mirror of the heliostat), height of the heliostat and/or of the mirror from the ground, and height of the tower from the ground can also be provided. The method 500 also includes the step 520 of calculating a minimum radial distance R_{MIN} (e.g., for each row of the heliostat field). The minimum radial distance R_{MIN} is the distance that inhibits (e.g., prevents) blocking of reflected sunlight of a heliostat by another heliostat in a row closer to the tower. The method 500 also includes the step 530 of calculating a minimum angular distance θ_{MIN}. The minimum angular distance θ_{MIN} is the distance that inhibits (e.g., prevents) collision between adjacent (e.g., tangentially, side-by-side) heliostats in a heliostat field. The method 500 also includes the step 540 of optimizing the layout of heliostats in a heliostat field (e.g., based on the inputs, the minimum radial distance R_{MIN} and the minimum angular distance θ_{MIN}).

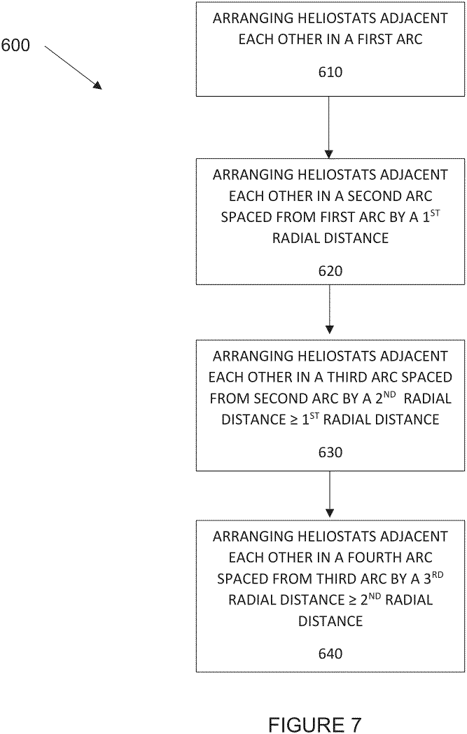

FIG. 7 shows a process or method 600 for implementing a layout of heliostats in a heliostat field. The method 600 includes the step 610 of arranging heliostats adjacent each other (e.g., tangentially, side-by-side) in a first arc. The method also includes the step 620 of arranging heliostats adjacent each other (e.g., tangentially, side-by-side) in a second arc spaced from the first arc by a 1^{st} radial distance. The method also includes the step 630 of arranging heliostats adjacent each other (e.g., tangentially, side-by-side) in a third arc spaced from the second arc by a 2^{nd} radial distance that is greater than or equal to the 1^{st} radial distance. The method also includes the step 640 of arranging heliostats adjacent each other (e.g., tangentially, side-by-side) in a fourth arc spaced from the third arc by a 3^{rd} radial distance that is greater than or equal to the 2^{nd} radial distance. The method can include arranging heliostats in fewer or more arcs that are spaced apart from each other, each additional arc spaced from a previous arc by a radial distance that defines an aisle, such that the radial distance between adjacent arcs increases in a direction away from the tower (e.g., for rows farther from the tower, while rows closer to the tower can have the same radial distance).

### Additional Embodiments

In embodiments of the present disclosure, a heliostat field layout system and method for a concentrated solar power (CSP) plant may be in accordance with any of the following clauses:

Clause 1: A heliostat field layout system for a concentrated solar power (CSP) plant, comprising:
a plurality of heliostats arranged adjacent each other in a first arc spaced from a tower comprising a solar receiver; and
a second plurality of heliostats arranged adjacent each other in one or more additional arcs spaced from each other and spaced from the first arc, each of the one of more additional arcs spaced from a previous of the one or more additional arcs by a radial distance that defines an aisle, the radial distance between a pair of adjacent arcs being equal to or greater than the radial distance between a previous pair of adjacent arcs in a direction away from the tower,
wherein each heliostat in the plurality of heliostats and in the second plurality of heliostats is configured to pivot about a pitch axis and about a roll axis.

Clause 2: The system of Clause 1, wherein the plurality of heliostats and the second plurality of heliostats are arranged tangentially in the first arc and the one or more additional arcs to inhibit collision between adjacent heliostats when in motion.

Clause 3: The system of Clause 2, wherein the plurality of heliostats and the second plurality of heliostats are arranged tangentially in a non-staggered manner.

Clause 4: The system of any preceding clause, wherein the first arc and the one or more additional arcs are circular arcs defined by a radius from the tower.

Clause 5: They system of any preceding clause, wherein each of the plurality of heliostats and the second plurality of heliostats has a size of between about 1.6 m x 1.2 m and about 4.8 m x 3.6 m.

Clause 6: They system of any preceding clause, wherein each of the plurality of heliostats and the second plurality of heliostats has a size of between about 2 m² and about 6 m².

Clause 7: The system of any preceding clause, wherein the radial distance increases between adjacent arcs in a direction away from the tower to inhibit sunlight directed to the receiver by each heliostat from being blocked by a heliostat of an arc closer to the receiver.

Clause 8: The system of any preceding clause, wherein the radial distance between adjacent arcs is equal to or greater than a minimum radial distance to inhibit sunlight directed to the receiver by each heliostat from being blocked by a heliostat of an arc closer to the receiver.

Clause 9: The system of any preceding clause, wherein the plurality of heliostats and the second plurality of heliostats are arranged tangentially in the first arc and the one or more additional arcs to inhibit each heliostat of the first plurality of heliostats and the second plurality of heliostats from casting a shadow on another heliostat of the first plurality of heliostats and the second plurality of heliostats.

Clause 10: The system of any preceding clause, wherein the plurality of heliostats and the second plurality of heliostats are arranged so that when viewed by the solar receiver they provide a field of view that is about entirely filled with mirrors of the plurality of heliostats and the second plurality of heliostats.

Clause 11: A method for implementing a layout of heliostats in a heliostat field of a concentrated solar power (CSP) plant, comprising:
arranging a plurality of heliostats adjacent each other in a first arc spaced from a tower comprising a solar receiver; and
arranging a second plurality of heliostats adjacent each other in one or more additional arcs spaced from each other and spaced from the first arc, each of the one of more additional arcs spaced from a previous of the one or more additional arcs by a radial distance that defines an aisle, the radial distance between a pair of adjacent arcs being equal to or greater than the radial distance between a previous pair of adjacent arcs in a direction away from the tower,
wherein each heliostat in the plurality of heliostats and in the second plurality of heliostats is configured to pivot about a pitch axis and about a roll axis.

Clause 12: The method of Clause 11, wherein arranging the plurality of heliostats and the second plurality of heliostats includes arranging the plurality of heliostats and the second plurality of heliostats tangentially in the first arc and the one or more additional arcs to inhibit collision between adjacent heliostats when in motion.

Clause 13: The method of Clause 12, wherein arranging the plurality of heliostats and the second plurality of heliostats tangentially includes arranging them in a non-staggered manner.

Clause 14: The method of any of Clauses 11-13, wherein the first arc and the one or more additional arcs are circular arcs defined by a radius from the tower.

Clause 15: The method of any of Clauses 11-14, wherein each of the plurality of heliostats and the second plurality of heliostats has a size of between about 1.6 m x 1.2 m and about 4.8 m x 3.6 m.

Clause 16: The method of any of Clauses 11-15, wherein each of the plurality of heliostats and the second plurality of heliostats has a size of between about 2 m² and about 6 m².

Clause 17: The method of any of Clauses 11-16, wherein the radial distance between adjacent arcs in a direction away from the tower is configured to inhibit sunlight directed to the receiver by each heliostat from being blocked by a heliostat of an arc closer to the receiver.

Clause 18: The method of any of Clauses 11-17, wherein the radial distance between adjacent arcs is equal to or greater than a minimum radial distance to inhibit sunlight directed to the receiver by each heliostat from being blocked by a heliostat of an arc closer to the receiver.

Clause 19: The method of any of Clauses 11-18, wherein arranging the plurality of heliostats and arranging the second plurality of heliostats includes arranging the heliostats to inhibit each heliostat of the first plurality of heliostats and the second plurality of heliostats from casting a shadow on another heliostat of the first plurality of heliostats and the second plurality of heliostats.

Clause 20: The method of any of Clauses 11-19, wherein the plurality of heliostats and the second plurality of heliostats are arranged so that when viewed by the solar receiver provide a field of view that is about entirely filled with mirrors of the plurality of heliostats and the second plurality of heliostats.

While certain embodiments of the inventions have been described, these embodiments have been presented by way of example only, and are not intended to limit the scope of the disclosure. Indeed, the novel methods and systems described herein may be embodied in a variety of other forms. For example, though the system and method described herein is described for arranging heliostats in a heliostat field, one of skill in the art will recognize that the same system and method layout can be used for arranging photovoltaic (PV) panels in a photovoltaic panel field (e.g., where the heliostat can be replaced by a PV unit and the mirror can be replaced by the PV panel). Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, embodiment, or example are to be understood to be applicable to any other aspect, embodiment or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing embodiments. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some embodiments, the actual steps taken in the processes illustrated and/or disclosed may differ from those shown in the figures. Depending on the embodiment, certain of the steps described above may be removed, others may be added. Furthermore, the features and attributes of the specific embodiments disclosed above may be combined in different ways to form additional embodiments, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular embodiment. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain embodiments include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain embodiments require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may refer to an amount that is within less than 10% of, within less than 5% of, within less than 1% of, within less than 0.1% of, and within less than 0.01% of the stated amount. As another example, in certain embodiments, the terms “generally parallel” and “substantially parallel” refer to a value, amount, or characteristic that departs from exactly parallel by less than or equal to 15 degrees, 10 degrees, 5 degrees, 3 degrees, 1 degree, or 0.1 degree.

The scope of the present disclosure is not intended to be limited by the specific disclosures of preferred embodiments in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

Of course, the foregoing description is that of certain features, aspects and advantages of the present invention, to which various changes and modifications can be made without departing from the spirit and scope of the present invention. Moreover, the devices described herein need not feature all of the objects, advantages, features and aspects discussed above. Thus, for example, those of skill in the art will recognize that the invention can be embodied or carried out in a manner that achieves or optimizes one advantage or a group of advantages as taught herein without necessarily achieving other objects or advantages as may be taught or suggested herein. In addition, while a number of variations of the invention have been shown and described in detail, other modifications and methods of use, which are within the scope of this invention, will be readily apparent to those of skill in the art based upon this disclosure. It is contemplated that various combinations or subcombinations of these specific features and aspects of embodiments may be made and still fall within the scope of the invention. Accordingly, it should be understood that various features and aspects of the disclosed embodiments can be combined with or substituted for one another in order to form varying modes of the discussed devices.

What is claimed is:

1. A heliostat field layout system for a concentrated solar power (CSP) plant, comprising:
a plurality of heliostats arranged adjacent each other in a first arc spaced from a tower comprising a solar receiver; and
a second plurality of heliostats arranged adjacent each other in one or more additional arcs spaced from each other and spaced from the first arc, each of the one of more additional arcs spaced from a previous of the one or more additional arcs by a radial distance that defines an aisle, the radial distance between a pair of adjacent arcs being equal to or greater than the radial distance between a previous pair of adjacent arcs in a direction away from the tower,
wherein each heliostat in the plurality of heliostats and in the second plurality of heliostats is configured to pivot about a pitch axis and about a roll axis.

2. The system of claim 1, wherein the plurality of heliostats and the second plurality of heliostats are arranged tangentially in the first arc and the one or more additional arcs to inhibit collision between adjacent heliostats when in motion.

3. The system of claim 2, wherein the plurality of heliostats and the second plurality of heliostats are arranged tangentially in a non-staggered manner.

4. The system of claim 1, wherein the first arc and the one or more additional arcs are circular arcs defined by a radius from the tower.

5. They system of claim 1, wherein each of the plurality of heliostats and the second plurality of heliostats has a size of between about 1.6 m x 1.2 m and about 4.8 m x 3.6 m.

6. They system of claim 1, wherein each of the plurality of heliostats and the second plurality of heliostats has a size of between about 2 m² and about 6 m².

7. The system of claim 1, wherein the radial distance increases between adjacent arcs in a direction away from the tower to inhibit sunlight directed to the receiver by each heliostat from being blocked by a heliostat of an arc closer to the receiver.

8. The system of claim 1, wherein the radial distance between adjacent arcs is equal to or greater than a minimum radial distance to inhibit sunlight directed to the receiver by each heliostat from being blocked by a heliostat of an arc closer to the receiver.

9. The system of claim 1, wherein the plurality of heliostats and the second plurality of heliostats are arranged tangentially in the first arc and the one or more additional arcs to inhibit each heliostat of the first plurality of heliostats and the second plurality of heliostats from casting a shadow on another heliostat of the first plurality of heliostats and the second plurality of heliostats.

10. The system of claim 1, wherein the plurality of heliostats and the second plurality of heliostats are arranged so that when viewed by the solar receiver they provide a field of view that is about entirely filled with mirrors of the plurality of heliostats and the second plurality of heliostats.

11. A method for implementing a layout of heliostats in a heliostat field of a concentrated solar power (CSP) plant, comprising:
arranging a plurality of heliostats adjacent each other in a first arc spaced from a tower comprising a solar receiver; and
arranging a second plurality of heliostats adjacent each other in one or more additional arcs spaced from each other and spaced from the first arc, each of the one of more additional arcs spaced from a previous of the one or more additional arcs by a radial distance that defines an aisle, the radial distance between a pair of adjacent arcs being equal to or greater than the radial distance between a previous pair of adjacent arcs in a direction away from the tower,
wherein each heliostat in the plurality of heliostats and in the second plurality of heliostats is configured to pivot about a pitch axis and about a roll axis.

12. The method of claim 11, wherein arranging the plurality of heliostats and the second plurality of heliostats includes arranging the plurality of heliostats and the second plurality of heliostats tangentially in the first arc and the one or more additional arcs to inhibit collision between adjacent heliostats when in motion.

13. The method of claim 12, wherein arranging the plurality of heliostats and the second plurality of heliostats tangentially includes arranging them in a non-staggered manner.

14. The method of claim 11, wherein the first arc and the one or more additional arcs are circular arcs defined by a radius from the tower.

15. The method of claim 11, wherein each of the plurality of heliostats and the second plurality of heliostats has a size of between about 1.6 m x 1.2 m and about 4.8 m x 3.6 m.

16. The method of claim 11, wherein each of the plurality of heliostats and the second plurality of heliostats has a size of between about 2 m² and about 6 m².

17. The method of claim 11, wherein the radial distance between adjacent arcs in a direction away from the tower is configured to inhibit sunlight directed to the receiver by each heliostat from being blocked by a heliostat of an arc closer to the receiver.

18. The method of claim 11, wherein the radial distance between adjacent arcs is equal to or greater than a minimum radial distance to inhibit sunlight directed to the receiver by each heliostat from being blocked by a heliostat of an arc closer to the receiver.

19. The method of claim 11, wherein arranging the plurality of heliostats and arranging the second plurality of heliostats includes arranging the heliostats to inhibit each heliostat of the first plurality of heliostats and the second plurality of heliostats from casting a shadow on another heliostat of the first plurality of heliostats and the second plurality of heliostats.

20. The method of claim 11, wherein the plurality of heliostats and the second plurality of heliostats are arranged so that when viewed by the solar receiver provide a field of view that is about entirely filled with mirrors of the plurality of heliostats and the second plurality of heliostats.
